(19) United States
(12) Patent Application Publication
(10) Pub. No.: US 2026/0111138 A1
(43) Pub. Date: Apr. 23, 2026

(54) METHOD FOR MIGRATING MEMORY DATA, APPARATUS, AND ELECTRONIC DEVICE

(71) Applicant: Lenovo (Beijing) Limited, Beijing (CN)

(72) Inventor: Dong WANG, Beijing (CN)

(21) Appl. No.: 19/358,720

(22) Filed: Oct. 15, 2025

(30) Foreign Application Priority Data
Oct. 18, 2024 (CN) 202411464612.6

(51) Int. Cl. G06F 3/06

(52) U.S. Cl. CPC G06F 3/0647; G06F 3/0611; G06F 3/064; G06F 3/0683

(57) ABSTRACT

A method for migrating memory data includes: obtaining a migration instruction for a target process; the target process including at least one target thread; and in response to the migration instruction, executing the following migration process for the target thread: obtaining memory data corresponding to the at least one target thread; determining whether the memory data is exclusively used by the target process; when the memory data is exclusively used by the target process, migrating the memory data to a target memory block; and when the memory data is not exclusively used by the target process, retaining the memory data in an original memory block.

### CROSS-REFERENCE TO RELATED APPLICATION(S)

This application claims priority to Chinese Patent Application No. 202411464612.6 filed on Oct. 18, 2024, which is incorporated herein by reference in its entirety.

### FIELD OF THE TECHNOLOGY

The present disclosure relates to a field of computer technology, and in particular to a method, apparatus, and electronic device for migrating memory data.

### BACKGROUND

Under certain hardware architectures, when a process migrates between physical cores, the memory data corresponding to the process needs to be moved between the memory blocks corresponding to the physical cores, such as a numanode.

Currently, this is typically done using the migratepages method, which leverages user-mode interfaces exposed by the kernel to migrate all of the process's memory data to a particular memory block.

However, this method of global memory migration may increase system overhead.

### SUMMARY

In one aspect, the present disclosure provides a method for migrating memory data. The method includes: obtaining a migration instruction for a target process; the target process including at least one target thread; and in response to the migration instruction, executing the following migration process for the target thread: obtaining memory data corresponding to the at least one target thread; determining whether the memory data is exclusively used by the target process; when the memory data is exclusively used by the target process, migrating the memory data to a target memory block; and when the memory data is not exclusively used by the target process, retaining the memory data in an original memory block.

In another aspect, the present disclosure provides an electronic device. The device includes: a memory storing computer program instructions; and a processor coupled to the memory and configured to execute the computer program instructions and perform: obtaining a migration instruction for a target process; the target process including at least one target thread; and in response to the migration instruction, executing the following migration process for the target thread: obtaining memory data corresponding to the at least one target thread; determining whether the memory data is exclusively used by the target process; when the memory data is exclusively used by the target process, migrating the memory data to a target memory block; and when the memory data is not exclusively used by the target process, retaining the memory data in an original memory block.

In yet another aspect, the present disclosure provides a non-transitory computer-readable storage medium storing computer program instructions executable by at least one processor to perform: obtaining a migration instruction for a target process; the target process including at least one target thread; and in response to the migration instruction, executing the following migration process for the target thread: obtaining memory data corresponding to the at least one target thread; determining whether the memory data is exclusively used by the target process; when the memory data is exclusively used by the target process, migrating the memory data to a target memory block; and when the memory data is not exclusively used by the target process, retaining the memory data in an original memory block.

### BRIEF DESCRIPTION OF THE DRAWINGS

To more clearly illustrate the technical solutions of certain embodiments of the present disclosure, the following briefly describes the figures used in describing the embodiments. The figures described below represent only certain embodiments of the present disclosure. Persons skilled in the technical field may derive other figures based on these figures without inventive effort.

FIG. 1 is a flow chart of a method for migrating memory data provided in certain embodiments of present disclosure;

FIG. 2 is an exemplary diagram of a memory pool architecture in certain embodiments of present disclosure;

FIG. 3 is a flowchart of a method for migrating memory data provided in certain embodiments of the present disclosure;

FIG. 4 is a partial flowchart of a method for migrating memory data provided in certain embodiments of the present disclosure;

FIG. 5 is a schematic diagram of the structure of a memory data migration device provided in certain embodiments of the present disclosure;

FIG. 6 is a schematic diagram of the structure of an electronic device provided in certain embodiments of the present disclosure;

FIG. 7 is a flowchart illustrating an internal active migration of heap data by each thread in certain embodiments of the present disclosure;

FIG. 8 is a flowchart illustrating an external passive migration of so files, bin files, and stack data by a third-party process in a single-thread scenario in certain embodiments of the present disclosure; and FIG. 9 is a flowchart illustrating an external passive migration of so files, bin files, and stack data by a third-party process in a multi-thread scenario in certain embodiments of the present disclosure.

### DETAILED DESCRIPTION

The following is combined with the drawings in certain embodiments of present disclosure to describe the technical solutions in the embodiments of present disclosure. The embodiments described are only part of the embodiments of present disclosure, not all of the embodiments. Based on the embodiments in present disclosure, all other embodiments obtained by persons in the technical field without making creative efforts are within the scope of protection of present disclosure.

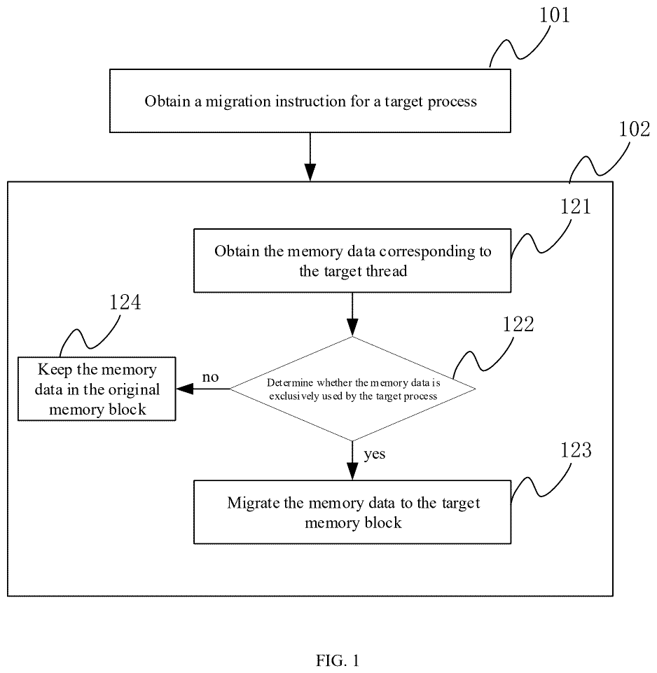

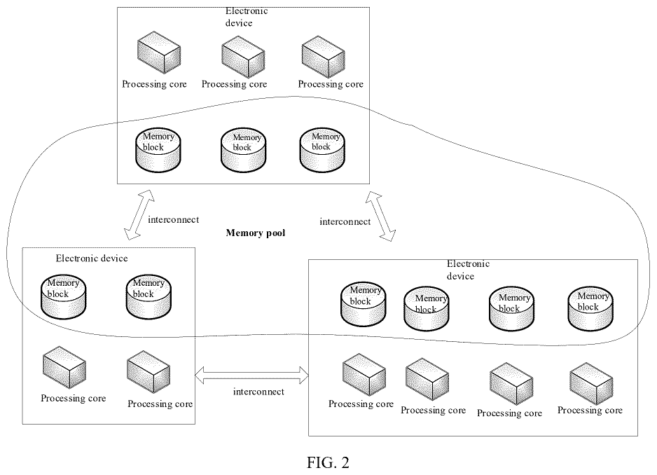

Referring to FIG. 1, there is shown a flowchart for implementing a method for migrating memory data provided in certain embodiments of the present disclosure. This method may be applied to an electronic device having a processing core and memory blocks for process operation. As shown in FIG. 2, multiple electronic devices are interconnected, and the memory blocks provided by each electronic device constitute a memory pool. Thus, the memory pool includes multiple memory blocks, which are provided by multiple interconnected electronic devices. Among them, an electronic device may provide one or more memory blocks. In addition, the electronic device also provides a processing core corresponding to the memory block. Among them, the storage performance of the memory blocks provided by different electronic devices is the same or different, and the processing performance of the processing cores provided by different electronic devices is the same or different. In one embodiment, the memory pool may be constructed based on multiple electronic devices through the Compute Express Link (CXL). Furthermore, the processing cores and memory blocks provided by these multiple electronic devices may use the non-uniform memory access NUMA (Non Uniform Memory Access) architecture to implement memory access. Based on this, the method for migrating memory data in certain embodiments may be applicable to the memory data migration scenario between any two memory blocks in the memory pool, including memory migration between memory blocks in the same electronic device, and also including memory migration between memory blocks in different electronic devices. The technical solution in certain embodiments is used to improve the efficiency of memory data migration.

In certain embodiments, the method in certain embodiments may include the following steps:

Step 101: Obtain a migration instruction for a target process.

The target process includes at least one target thread.

In certain embodiments, the migration instruction is generated when a thread in the target process undergoes core migration. The migration instruction of the target process is used to instruct each target thread in the target process to migrate from the current processing core to the target processing core. The processing cores of different target threads after migration may be the same or different. The target thread here may be understood as the thread where the processing core migration occurs. For example, the target process has 5 target threads: thread 1 to thread 5. When migrating the target process, thread 1, thread 2 and thread 3 are migrated to processing core a, thread 4 is migrated to processing core b, and thread 5 is migrated to processing core c. Processing core a and processing core c are on the same electronic device, and processing core b is on another electronic device. The processing cores where each target thread is located before and after migration may be on the same electronic device or on different electronic devices.

In certain embodiments, the migration instruction also instructs the migration of memory data corresponding to each target thread.

Step 102: In response to the migration instruction, execute the migration process at steps 121 to 124 for the target thread.

Certain embodiments utilize threads as the migration unit for memory data migration, thereby achieving fine-grained memory data migration. In certain embodiments, the migration process described at steps 121 to 124 is executed for each target thread. The details are as follows:

Step 121: Obtain the memory data corresponding to the target thread.

Memory data may include heap data, stack data, shared object files, and binary files corresponding to the target thread. Heap data refers to the data stored in the heap memory (heap space) allocated to each target thread in the target process. Stack data refers to the data stored in the stack memory (stack space) allocated to each target thread in the target process. Binary files are files in the bin format, used to store data, program code, and other content. Shared object files are files in the so format, also known as shared object files or shared library files.

The target thread in certain embodiments refers to the thread in the target process that requires memory data migration. In other words, the target thread is the thread in the target process that has undergone core migration. In one embodiment, information about the processing core to which the thread has migrated may be obtained by calling the kernel's syscall interface. Based on this, in certain embodiments, when each thread in the target process is running, it calls the syscall interface to obtain information about the processing core at which the thread is positioned. This information is then compared with the thread's previously recorded core information. When the comparison is inconsistent, it is determined that the thread has undergone core migration and the thread is designated as the target thread.

Step 122: Determine whether the memory data is exclusively used by the target process. If so, proceed to step 123. If not, proceed to step 124.

Step 123: Migrate the memory data to the target memory block.

Step 124: Keep the memory data in the original memory block.

The original memory block is the memory block where the memory data originally resides. The target memory block is a memory block distinct from the original memory block.

Based on this, when the target process exclusively uses the memory data, migrating the memory data will not affect the normal operation of other processes. In this scenario, the memory data may be migrated to a target memory block that is distinct from the original memory block. When the memory data is not exclusively used by the target process, it indicates that other processes are also using the memory data. In this scenario, the memory data remains in the original memory block. This allows for thread-based memory migration while ensuring that the normal operation of other processes is not affected.

By utilizing the above technical solution, certain embodiments of the present disclosure provide a method for migrating memory data. In response to a migration instruction from a target process, after obtaining the corresponding memory data for each thread in the target process, the method first determines whether the data is exclusively used by the target process. Exclusive memory data is migrated to the target memory block, while non-exclusive memory data remains in the original memory block. As may be seen, certain embodiments migrate exclusive memory data on a thread-by-thread basis within a process, rather than migrating all of the process's memory data to a single memory block. This decentralization reduces the burden on the system and improves the efficiency of memory data migration.

In one embodiment, the memory data includes heap data corresponding to the target thread. Heap data is data occupied by the target thread and may also be occupied by other threads. That is, the data in the thread's allocated heap memory is visible to and may be shared with other threads in the process, but it cannot be occupied by threads in other processes. Therefore, the heap data corresponding to the target thread is definitely exclusive to the target process.

Based on this, migrating memory data to the target memory block at step 123 may be achieved as follows:

First, target data that meets the migration condition is selected from the heap data.

Then, the target thread calls the memory page migration interface, which migrates the target data to the target memory block.

The target memory block is the memory block corresponding to the processing core to which the target thread will be migrated. The memory block corresponding to the processing core provides the memory area for the processing core to perform data calculations.

In certain embodiments, the memory block corresponding to processing core refers to the proximal memory block of the processing core at the hardware level. The proximal memory block of one processing core may be considered remote memory block by other processing cores, and for a processing core, proximal memory block of other processing core may be considered remote memory blocks. A processing core has the fastest access speed when accessing data in its proximal memory blocks.

Based on this, in certain embodiments, for heap data, the target thread itself may preferentially call the memory page migration interface to migrate the target data in the heap data that meets the migration condition to the target memory block. In this way, the migration of memory data may be achieved by the target thread itself without the help of the migration process, thereby reducing the proximal (local) memory space, that is, reducing the memory space consumed by the device performing the migration during the memory data migration process.

In one embodiment, the memory page migration interface may be a movepage interface in an operating system, which may migrate memory data.

Based on the above implementation, migration condition may include: all heap data, all heap data exclusively used by the target thread, or at least a portion of the heap data exclusively used by the target thread and accessed at a frequency greater than or equal to a threshold. The threshold may be set as needed. The access frequency of memory data may be recorded in a corresponding field of the memory data through data statistics. Based on this, in certain embodiments, the access frequency of the memory data may be read from this field. Memory data exclusively used by the target thread and accessed at a frequency greater than or equal to the threshold is then selected as the target data meeting the migration condition.

In certain embodiments, the migration condition may be configured as needed. The target data in the heap data that meets the migration condition is stored in a hotspot area, such as a global hotspot memory list called pagelist. In certain embodiments, the target data in the heap data that meets the migration condition may be read from the hotspot area.

For example, in certain embodiments, the target thread may call the movepage interface to migrate all heap data, or a portion of the heap data exclusively used by the target thread, to the memory block corresponding to the processing core where the target thread will be migrated.

For another example, in certain embodiments, the target thread may migrate hot data in the portion of heap data exclusively used by the target thread to the memory block corresponding to the processing core where the target thread is positioned after migration by calling the movepage interface. Hot data in the heap data refers to data in the heap data whose access frequency is greater than or equal to a threshold, that is, data frequently accessed by users.

It may be seen that in certain embodiments, exclusive memory data migration is performed on a thread-by-thread basis in the process, rather than migrating the entire memory data of the process to one memory block. This method of decentralization may reduce the burden on the system. Moreover, for heap data, in certain embodiments, data that meets the migration condition is migrated to the proximal memory block, which may save proximal memory space, improve the efficiency of memory data migration, and optimize program running performance.

In one embodiment, when there is only one target thread in the target process, for memory data of any data type, the target memory block is the memory block corresponding to the processing core where the target thread is positioned after migration. The memory block corresponding to the processing core may provide a memory area for the processing core to perform data calculations, that is, the proximal memory block of the processing core.

For example, when the target process has one target thread, thread 1, and thread 1 is migrated to processing core c, the target memory block is the memory block corresponding to core c, that is, the proximal memory block of processing core c. Therefore, when the memory data corresponding to thread 1 is exclusively used by the target process, it will be migrated to the memory block corresponding to processing core c.

When there are multiple target threads in the target process, the target memory blocks include: memory blocks corresponding to the processing cores where a number of the target threads in the target process are positioned after migration and the number is greater than a target number, and the target memory blocks corresponding to the processing cores where the target threads are positioned after migration.

In one embodiment, the target memory blocks to which memory data of different data types are migrated may be different. For example, for memory data of a first data type, such as a binary file or a shared object file, the target memory block to which the memory data of the first data type is migrated is the memory block corresponding to the processing core to which a number of target threads in the target process are migrated and the number is greater than a target number. For memory data of a second data type, such as stack data or heap data, the target memory block to which the memory data of the second data type is migrated is the memory block corresponding to the processing core to which the target threads are migrated.

The target number here may be a value corresponding to the maximum number of threads running on the processing core where each thread in the target process is migrated. For example, the number obtained by subtracting 1 from the maximum value is set as the target number.

For example, when the target process has five target threads: threads 1 to 5, threads 1, 2, and 3 are migrated to processing core a, thread 4 is migrated to processing core b, and thread 5 is migrated to processing core c. In this scenario, the target number may be 2. Based on this, for the so file and bin file corresponding to each thread, the target memory block is the memory block corresponding to processing core a, and for the heap data and stack data of each thread, the target memory block is the memory block corresponding to the processing core where each thread is positioned. Therefore, when migrating memory data, when the bin files and so files corresponding to threads 1 to thread 5 are exclusively used by the target process, then these bin files and so files exclusively used by the target process are migrated to the memory block corresponding to processing core a, the heap data and stack data that meet the migration condition of thread 1 are migrated to the memory block corresponding to processing core a, the heap data and stack data that meet the migration condition of thread 2 are migrated to the memory block corresponding to processing core a, the heap data and stack data that meet the migration condition of thread 3 are migrated to the memory block corresponding to processing core a, the heap data and stack data that meet the migration condition of thread 4 are migrated to the memory block corresponding to processing core b, and the heap data and stack data that meet the migration condition of thread 5 are migrated to the memory block corresponding to processing core c.

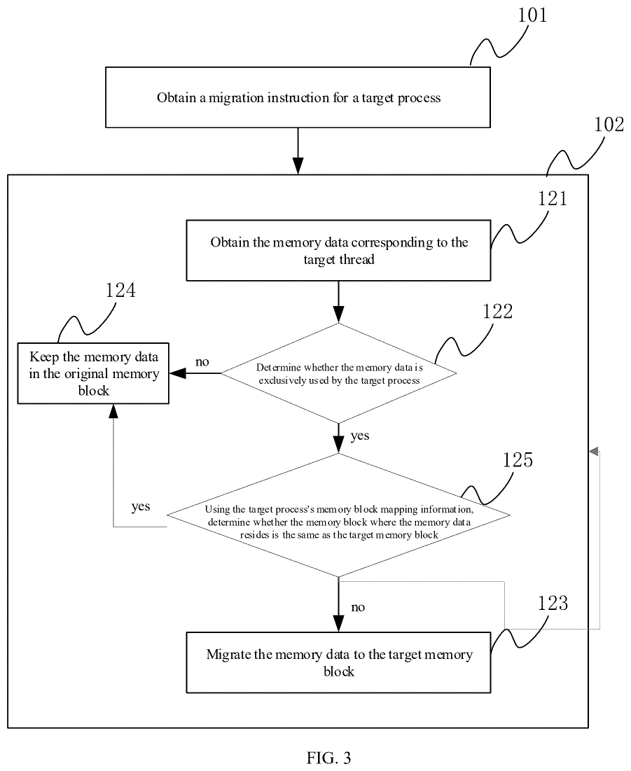

Based on the above implementation, certain embodiments may also include the following processing before step 123, as shown in FIG. 3:

Step 125: Using the target process's memory block mapping information, determine whether the memory block where the memory data resides is the same as the target memory block. If so, execute step 124; if not, execute step 123.

For example, the target process's memory block mapping information is stored in the numa_maps file. This file provides at least the memory mapping information allocated to each thread in the process. The numa_maps file may be found in the /proc/pid/numa_maps directory, where pid is the process identification of the target process. By viewing the numa_maps file, you may determine the memory allocation objects and addresses of the task. Based on this, in certain embodiments, after reading the numa_maps file, the memory block where the memory data corresponding to each target thread in the target process is positioned may be searched in the numa_maps file. Thus, in certain embodiments, the memory block where the memory data corresponding to the target thread is positioned may be compared with the target memory block. When the comparison is consistent, the memory data does not need to be migrated, that is, the memory data remains in the original memory block. At this time, the original memory block is the memory block corresponding to the processing core where the target thread is positioned after migration, or the original memory block is the memory block corresponding to the processing core where a number of target threads are positioned after migration and the number is greater than target number. When the comparison is inconsistent, the memory data is migrated to the target memory block. At this time, the target memory block is not the same memory block as the original content block.

It may be seen that in certain embodiments, when the target process includes multiple target threads, the memory block mapping information of the target process is first used to determine whether the original memory block where the memory data is positioned is the memory block corresponding to the processing core where the target threads exceeding the target number are migrated. This may avoid migrating the memory data in the same memory block, thereby saving the memory resources used by the migration and improving the migration efficiency.

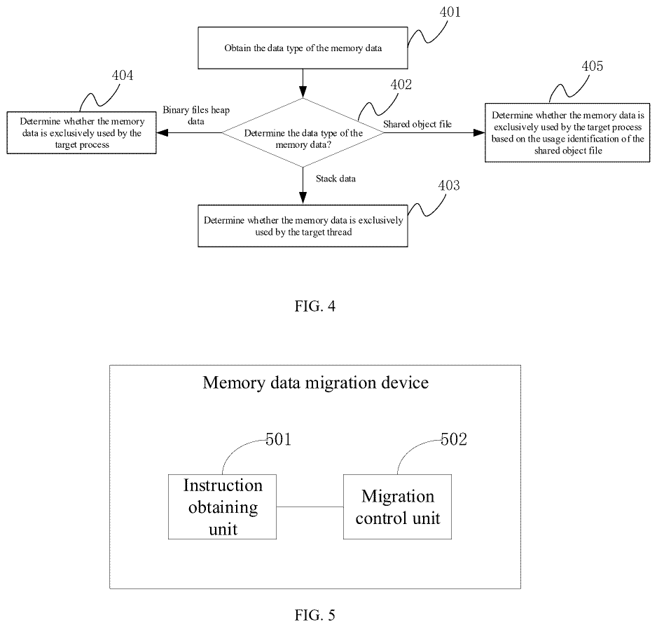

In one embodiment, determining whether the memory data is exclusively used by the target process at step 122 may be accomplished as follows, as shown in FIG. 4:

Step 401: Obtain the data type of the memory data.

The memory data may include various data types, such as heap data, stack data, binary files, or shared object files.

Step 402: Determine the data type of the memory data. When the memory data is stack data, execute step 403; when the memory data is heap data, execute step 404; when the memory data is a binary file, execute step 404; when the memory data is a shared object file, execute step 405.

Step 403: Determine whether the memory data is exclusively used by the target thread.

The data type of the stack data is exclusively used by the thread to which it belongs. When it is exclusively used by the thread, it may be determined that it is exclusively used by the process to which the thread belongs. The data type of the heap data is exclusively used by the process. Thus, for the memory data of the stack data, it may be determined that the memory data of the stack data type corresponding to the target thread is exclusively used by the target process. Based on this, in certain embodiments, the memory data of this stack data type is migrated to the target memory block, such as the memory block corresponding to the processing core to which the target thread is migrated, for example, the proximal memory block.

Step 404: Determine whether the memory data is exclusively used by the target process.

The target thread's heap data may be used by one or more threads within the same process, but not by other processes. A binary file may be used by one or more threads within the same process, but not by other processes. Therefore, for the heap data memory, it may be determined that the memory data of the heap data whose data type corresponding to the target thread is exclusively used by the target process. Based on this, in certain embodiments, the memory data in the heap data that meets the migration condition is migrated to the target memory block. Regarding the memory data of binary files, it may be determined that the memory data of the binary file data type corresponding to the target thread is exclusively used by the target process. Based on this, in certain embodiments, the memory data of these binary files is migrated to the target memory block.

Step 405: Determine whether the memory data is exclusively used by the target process based on the usage identification of the shared object file.

A shared object file may be used by one or more processes. A shared object file has a usage identification corresponding to it, which may be a numerical value representing the number of processes using the shared object file. For example, when the usage identification of a shared object file is 1, it indicates that the shared object file is used only by the process to which the thread belongs. When the usage identification of the shared object file is greater than 1, it indicates that the shared object file is used by not only the process to which the thread belongs, but also another process. Based on this, in certain embodiments, it may be determined whether the usage identification of the shared object file is 1 to determine whether the memory data is used by the target process. Based on this, in certain embodiments, when the usage identification of the shared object file is 1, the memory data of these shared object files are migrated to the target memory block. When the usage identification of the shared object file is greater than 1, the shared object file is not migrated to avoid affecting the normal operation of the process using the shared object file.

It may be seen that in certain embodiments, it is possible to determine whether memory data of different data types are exclusively used by the target process. In this way, memory data of different data types may be migrated separately to achieve fine-grained data migration in the data dimension, thereby reducing migration resource consumption to improve migration efficiency while ensuring the normal operation of other processes and improving the reliability of process operation.

In one embodiment, migrating the memory to the target memory block at step 123 may be accomplished by:

Based on the data address range of the memory data, a pre-arranged migration process is used to call a memory migration interface, which then migrates the memory data to the target memory block.

The migration process is a process different from the target process, and is a pre-arranged process primarily used to migrate memory data. In certain embodiments, the migration of memory data may be performed using the particularly arranged migration process, thereby accelerating the migration rate of the memory data and improving migration efficiency.

In certain embodiments, memory data of various data types exclusively used by the target process may be migrated using the migration process by calling the memory migration interface. However, for heap data, the target thread to which the memory data belongs may be preferentially used for migration, thereby reducing the memory resources used by data migration.

Based on the above implementation scheme, the data address range of the memory data may be obtained according to the address mapping information of the target process. The address mapping information may include mapping information between the memory data and the start and end ranges of the virtual memory addresses where the memory data is located.

For example, address mapping information may be obtained from the maps file, which is a file that displays the memory mapping information corresponding to each thread in the process. It is positioned in the /proc/pid/maps directory, where pid represents the process identification (ID). The memory mapping information (address mapping information) in the maps file includes: the mapping relationship between the memory data corresponding to each thread in the process and the start and end range including the starting and ending positions of the virtual memory addresses where these memory data are positioned. Based on this, in certain embodiments, the start and end range of the virtual memory address where the memory data is positioned may be obtained from the address mapping information, that is, the data address range of the memory data. Then, the migration process calls the memory migration interface such as the movepage interface according to the data address range, and the memory migration interface reads memory data such as binary files, shared object files, stack data, heap data, or the like according to the data address range and migrates the read memory data to the target memory block.

Referring to FIG. 5, a schematic diagram of the structure of a memory data migration device provided in certain embodiments of the present disclosure is shown. This device may be configured in an electronic device having a processing core and memory blocks for facilitating process execution, such as the electronic device shown in FIG. 2. The technical solution in certain embodiments is primarily intended to improve the efficiency of memory data migration.

The device in certain embodiments may include the following units:

Instruction obtaining unit 501, configured to obtain a migration instruction for a target process; the target process includes at least one target thread;

Migration control unit 502, configured to, in response to the migration instruction, execute the following migration process on the target thread:

Obtain memory data corresponding to the target thread;

Determine whether the memory data is exclusively used by the target process;

When the memory data is exclusively used by the target process, the memory data is migrated to the target memory block.

When the memory data is not exclusively used by the target process, the memory data remains in the original memory block.

As may be seen from the above technical solution, in the memory data migration device provided in certain embodiments of the present disclosure, in response to a migration instruction from a target process, after obtaining the corresponding memory data for each thread in the target process, the device first determines whether the data is exclusively used by the target process. Exclusive memory data is migrated to the target memory block, while non-exclusive memory data remains in the original memory block. As may be seen, certain embodiments migrate exclusive memory data on a thread-by-thread basis within a process, rather than migrating all of the process's memory data to a single memory block. This decentralization reduces the burden on the system and improves the efficiency of memory data migration.

In one embodiment, the memory data includes: heap data corresponding to the target thread;

When migrating the memory data to the target memory block, the migration control unit 502 is configured to: select the target data that meets the migration condition from the heap data; utilize the target thread to call a memory page migration interface, and use the memory page migration interface to migrate the target data to the target memory block. The target memory block is the memory block corresponding to the processing core to which the target thread is to be migrated, and the memory block corresponding to the processing core provides a memory area for the processing core to perform data calculations.

For example, the migration condition includes: all data in the heap data that is exclusively used by the target thread; or at least a portion of the data in the heap data that is exclusively used by the target thread and has an access frequency greater than or equal to a threshold.

In one embodiment, when there is only one target thread in the target process, the target memory block is the memory block corresponding to the processing core where the target thread is positioned after migration, and the memory block corresponding to the processing core provides a memory area for the processing core to perform data calculation; when there are multiple target threads in the target process, the target memory block is the memory block corresponding to the processing core where a number of the target threads are positioned after migration and the number is greater than a target number.

Based on this, when there are multiple target threads in the target process, the migration control unit 502 is configured to, before migrating the memory data to the target memory block, use the memory block mapping information of the target process to determine whether the memory block where the memory data is positioned is the same as the target memory block. The memory block mapping information includes mapping information between the memory data and the memory block where the memory data is positioned; when the memory block where the memory data is positioned is the same as the target memory block, the memory data remains in the original memory block; when the memory block where the memory data is positioned is different from the target memory block, the memory data is migrated to the target memory block.

In one embodiment, when determining whether the memory data is exclusively used by the target process, the migration control unit 502 is configured to: obtain a data type of the memory data; and when the memory data is stack data, determine that the memory data is exclusively used by the target thread. In the scenario where the memory data is heap data, it is determined that the memory data is exclusively used by the target process; in the scenario where the memory data is a binary file, it is determined that the memory data is exclusively used by the target process; in the scenario where the memory data is a shared object file, it is determined whether the memory data is exclusively used by the target process based on the usage identification of the shared object file.

In one embodiment, when the migration control unit 502 migrates the memory data to the target memory block, it is used to: call the memory page migration interface according to the data address range of the memory data using the pre-arranged migration process, and the memory page migration interface migrates the memory data to the target memory block.

The data address range of the memory data is obtained based on the address mapping information of the target process; the address mapping information includes mapping information between the memory data and the start and end ranges of the virtual memory addresses in which the memory data resides.

Implementation of each unit in certain embodiments may be found in the corresponding content above and will not be detailed here.

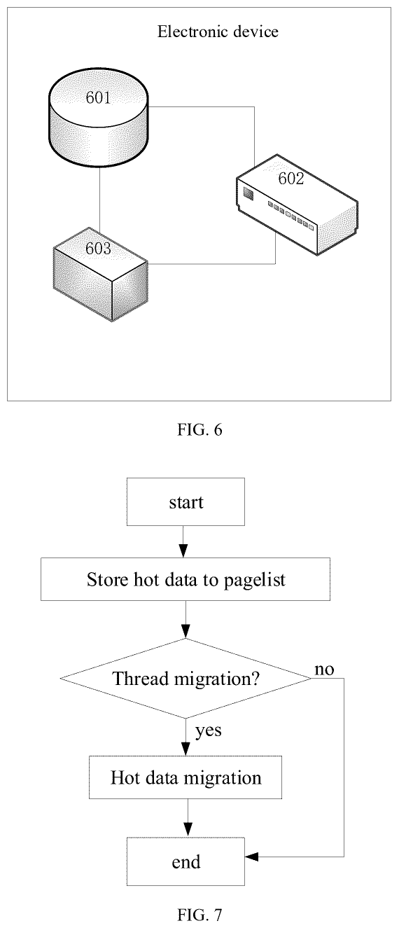

FIG. 6 is a schematic diagram of the structure of an electronic device provided in certain embodiments of the present disclosure. The electronic device may be any of the electronic devices shown in FIG. 2. The electronic device may include the following structures:

Memory block 601, implemented as a memory, for storing memory data;

Controller 602, configured to obtain a migration instruction for a target process; the target process includes at least one target thread; and in response to the migration instruction, execute the following migration process for the target thread:

Obtain memory data corresponding to the target thread;

Determine whether the memory data is exclusively used by the target process;

When the memory data is exclusively used by the target process, the memory data is migrated to the target memory block.

When the memory data is not exclusively used by the target process, the memory data remains in the original memory block.

In addition, the electronic device may also include a processing core 603, which is configured to run the target thread. Processing core 603 uses the memory area provided by memory block 601 to perform data calculations to run the corresponding target thread.

It may be seen from the above technical solution that in an electronic device provided by certain embodiments of the present disclosure, in response to the migration instruction of the target process, for each thread in the target process, after obtaining the corresponding memory data, it is first determined whether it is exclusively used by the target process. For exclusive memory data, it is migrated to the target memory block, and for non-exclusive memory data, it remains in the original memory block. It may be seen that in certain embodiments, exclusive memory data migration is performed on a thread-by-thread basis in the process, rather than migrating the entire memory data of the process to one memory block. This may reduce the burden on the system by decentralization, thereby improving the efficiency of memory data migration.

Taking a system architecture based on NUMA and CXL as an example, the following detailed description of the technical solution of the present disclosure is provided:

In a system architecture based on NUMA and CXL, different processing cores, such as central processing units (CPUs), access different memory blocks, such as data in numanodes, at varying rates. This results in tiered memory access latency. Therefore, optimizing software performance without increasing hardware costs becomes a key issue.

In certain existing technology, the migratepages API is often used to migrate the entire memory data of a process to a particular numanode. However, this migration solution may only migrate the entire process's memory data. When a numanode is running low on memory, migrating the entire memory data increases the system burden and wastes local memory.

To address the above issues, the present disclosure in certain embodiments provides an adaptive performance tuning method that combines internal and external resources. This combination may be understood as a combination of active and passive methods to rapidly migrate memory on demand. The following points are key:

Internal: This refers to memory data migration performed by the thread (code) itself. For example, internal is a thread-initiated active migration, which is triggered and processed by the thread according to logic. This part includes the following features.

(1) User-defined important hotspot memory: Customize the global hotspot memory list pagelist based on the execution logic of the own code.

(2) Thread running monitoring: After obtaining the processing core information such as CPU information, numanode information, process PID information, or the like, function encapsulated and recordation is performed. When the thread is running, the CPU and numanode information are compared. If the numanode is different, the thread will actively trigger the migration of key memory in the pagelist.

(3) Thread memory migration: To avoid memory migration affecting other processes or causing shared memory between processes to be migrated back and forth, in this scenario, when migrating the memory of each thread, use the move_page parameter with the MPOL_MF_MOVE function to migrate only the thread's exclusive memory, such as stack data and exclusive heap data, and the process's exclusive memory data, such as bin files and so files.

In certain embodiments, the migration is mainly performed on the heap area (for example, heap data). The heap areas of different threads may actively migrate the exclusive data in the heap areas they use to the corresponding numanode as the CPU scheduling of the threads progresses.

External: This refers to assisting memory migration tuning of a process from a third-party perspective. The third-party process (the migration process mentioned above) monitors and processes the target process. In this scenario, it is necessary to distinguish whether the tuning process is single-threaded or multi-threaded. This external intervention is passive, but it helps to quickly converge memory migration. The following describes the single-threaded and multi-threaded scenarios separately:

1. In the scenario of a single thread, the external single thread will obtain the execution numanode node, and the memory data has the following data types:

(1) Binary file: A bin file may be shared between threads within a process, but is definitely used exclusively by the process. Therefore, the bin file is entirely migrated.

(2) so files (shared object files): so files may be shared between processes. In this scenario, so files whose corresponding mapmax field is 1 (that is, so files exclusively used by the current process) are entirely migrated. so files whose mapmax field is of other values are not migrated to avoid affecting other task processes.

(3) Stack data: Stack data is memory data exclusively used by a thread, so the stack data is entirely migrated.

2. In the scenario of multiple threads, memory data has the following data types:

(1) bin file: The migration principle is: migrate to the numanode where most multi-threads run. This numanode is the memory block numanode corresponding to the processing core where the target threads whose number exceeding the target number are migrated.

(2) so file: Migrate the file with mapmax of 1 to the numanode corresponding to the processing core where most threads are migrated, while avoiding affecting other task processes

(3) Stack data: The stack data is entirely migrated to the numanode corresponding to the processing core where the thread is positioned after migration, that is, the proximal numanode.

Note:

A. Regarding the exclusivity check of so files, since multiple threads within a process share the so file mapping (mapmax), only the mapmax of the process or one of its threads needs to be checked.

B. Regarding stack data, since the stack data of multiple threads is independent, each thread needs to independently check the processing core on which it is running.

The following flowchart illustrates the memory migration logic for heap data, so files, bin files, and stack data:

FIG. 7 shows a flowchart for each thread's active migration of heap data. In certain embodiments, the following process is implemented using the so or .a function interface file:

First, the thread's hot heap data is stored in the global hotspot memory list, pagelist.

Then, it determines whether the thread has undergone core migration, that is, whether the heap data needs to be migrated to a numanode.

When migration is required, the thread calls the move_page interface to migrate the thread's exclusive hot data in the pagelist to the target memory block, such as the numanode corresponding to the CPU where the thread will be migrated.

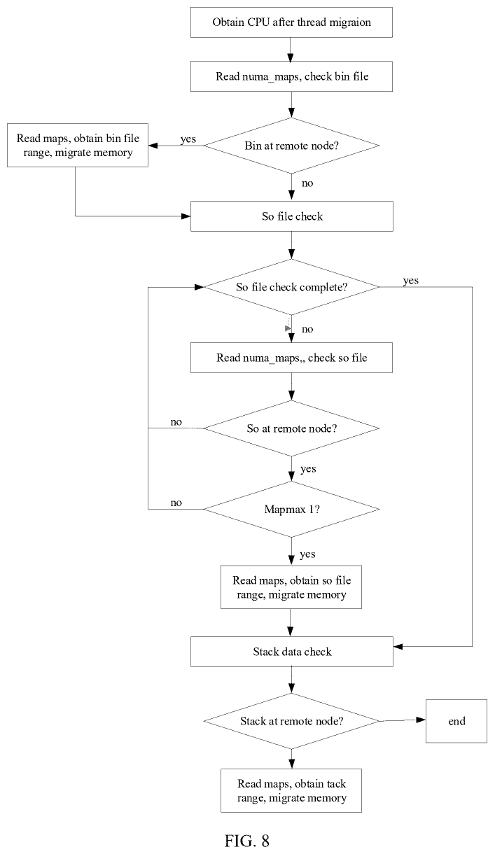

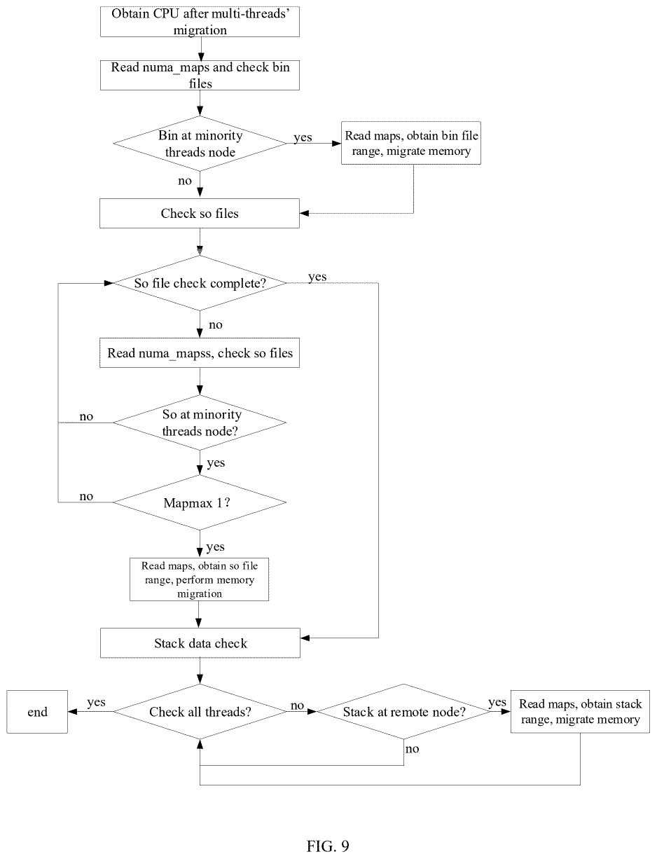

FIG. 8 shows the flow chart for passively migrating so files, bin files, and stack data via a third-party process in a single-threaded environment.

First, obtain the CPU where the thread is positioned after migration, that is, the target memory block mentioned above;

Then, by reading numa_maps, check the numanode where the bin file is positioned; determine whether the bin file is on the remote node. Here, the bin file is on the remote node means that the numanode where the bin file is positioned is inconsistent with the numanode corresponding to the CPU where the thread is migrated. When the bin file is not on the remote node, that is, the bin file is on the numanode corresponding to the CPU where the thread is migrated (the proximal numanode), then there is no need to migrate the bin file. When the bin file is on a remote node, the data address range of the bin file is obtained by reading maps, and then the move_page interface is called according to the data address range to migrate the bin file corresponding to the thread to the numanode corresponding to the CPU where the thread is positioned after migration.

After that, start checking the so file and check each so file as follows:

By reading numa_maps, check the numanode where the so file is positioned to determine whether the so file is on a remote node. Here, the so file is on a remote node means that the numanode where the so file is positioned is inconsistent with the numanode corresponding to the CPU where the thread is migrated. When the so file is not on the remote node, that is, the so file is on the numanode corresponding to the CPU where the thread is migrated (the proximal numanode), then there is no need to migrate the so file. When the so file is on a remote node, check whether mapmax is 1. If not, it indicates that the so file is not exclusively used by the process and does not need to be migrated. Then continue checking other so files. If mapmax is 1, obtain the data address range of the so file by reading maps, and then call the move_page interface according to the data address range to migrate the so file corresponding to the thread to the numanode corresponding to the CPU where the thread is migrated, until all so files are checked.

Finally, the stack data check begins: by reading numa_maps, checking the numanode where the stack data is positioned; determining whether the stack data is on a remote node. Here, stack data on a remote node means that the numanode where the stack data is positioned is inconsistent with the numanode corresponding to the CPU where the thread is positioned after migration. When the stack data is not on a remote node, that is, the stack data is on the numanode corresponding to the CPU where the thread is positioned after migration (the proximal numanode), then there is no need to migrate the stack data. When the stack data is on a remote node, the data address range of the stack data is obtained by reading maps, and then the move_page interface is called according to the data address range to migrate the stack data corresponding to the thread to the numanode corresponding to the CPU where the thread is positioned after migration.

FIG. 9 shows the flow chart for passively migrating so files, bin files, and stack data through a third-party process in a multi-threaded environment. The following steps are performed:

The CPU where most threads will be migrated (for example, the target memory block mentioned above) is obtained. The following checks are performed on each thread:

First, by reading numa_maps, check the numanode where the bin file is positioned; determine whether the bin file is in the node where a minority of threads are migrated or the node where the majority of threads are migrated (that is, the numanode corresponding to the CPU where the majority of threads are migrated). When the bin file is not in the node where a minority of threads are migrated, but is in the node where the majority of threads are migrated, then there is no need to migrate the bin file. When the bin file is in the node where a minority of threads are migrated, the data address range of the bin file is obtained by reading maps, and then the move_page interface is called according to the data address range to migrate the bin file corresponding to the thread to the numanode corresponding to the CPU where the thread is migrated.

After that, start checking the so file and check each so file as follows:

By reading numa_maps, check the numanode where the so file is positioned to determine whether the so file is positioned in the node where a minority of threads are migrated or in the node where a majority of threads are migrated (that is, the numanode corresponding to the CPU where majority of threads are migrated). When the so file is not positioned in the node where a minority of threads are migrated, but is positioned in the node where majority of threads are migrated, then the so file does not need to be migrated. When the so file is in the node where a minority of threads are migrated, then check whether mapmax is 1. When it is not 1, it means that it is not exclusively used by the process and the so file does not need to be migrated. Then continue to check other so files. When mapmax is 1, obtain the data address range of the so file by reading maps, and then call the move_page interface according to the data address range to migrate the so file corresponding to the thread to the numanode corresponding to the CPU where the thread is migrated, until all so files are checked.

Finally, start checking the stack data and perform the following checks on each thread:

By reading numa_maps, check the numanode where the stack data is positioned; determine whether the stack data is in the remote node. Here, the stack data in the remote node means that the numanode where the stack data is positioned is inconsistent with the numanode corresponding to the CPU where the thread is migrated; when the stack data is not in the remote node, then there is no need to migrate the stack data, and continue to check the next thread. When the stack data is in a remote node, the data address range of the stack data is obtained by reading maps, and then the move_page interface is called according to the data address range to migrate the stack data corresponding to the thread to the numanode corresponding to the CPU where the thread is positioned after migration, until all threads have been checked.

In summary, the technical solution of the present disclosure has the following advantages:

1. Internally, active migration is used instead of NUMA balancing. This ensures that processes are immediately aware of NUMA node migrations and proactively migrate key memory, avoiding the lag associated with NUMA balancing migrations.

2. Externally, passive migration is used, employing the move_pages method instead of the migratepages command. This abandons the global migration model and adopts a fine-grained memory migration model, further conserving local memory.

3. A more particular breakdown of multi-threaded scenarios is provided. In multi-threaded scenarios, some threads may run on node 1, while others may run on node 0. An entire migration will inevitably negatively impact the performance of some threads. Therefore, the present disclosure implements targeted strategic processing of stack data, so files, and bin files in both single-threaded and multi-threaded scenarios to avoid ineffective and harmful tuning.

The various embodiments in the present disclosure are described, with each embodiment focusing on the differences from other embodiments. Reference may be made to the common and similar parts between the various embodiments. For the devices disclosed in the embodiments, since they correspond to the methods disclosed in the embodiments, the description is relatively simple, and reference may be made to the method description for relevant parts.

Persons skilled in the technical field appreciate that the elements and algorithmic steps of each example described in conjunction with the embodiments disclosed herein may be implemented using electronic hardware, computer software, or a combination of both. To clearly illustrate the interchangeability of hardware and software, the above description generally describes the components and steps of each example based on their functionality. Whether these functions are implemented in hardware or software depends on the particular implementation and design constraints of the technical solution. Persons skilled in the technical field may use different methods to implement the described functions, but such implementations should not be considered beyond the scope of the present disclosure.

The steps of the methods or algorithms described in conjunction with the embodiments disclosed herein may be implemented directly using hardware, a software module executed by a processor, or a combination of the two. The software module may be placed in random access memory (RAM), internal memory, read-only memory (ROM), electrically programmable ROM, electrically erasable programmable ROM, registers, a hard disk, a removable disk, a CD-ROM, or any other suitable form of storage medium.

The above description of the disclosed embodiments is intended to enable persons skilled in the technical field to implement or use the present disclosure. Various modifications to these embodiments are readily apparent to persons skilled in the technical field, and the general principles defined herein may be implemented in other embodiments without departing from the spirit or scope of the present disclosure. Therefore, the present disclosure is not limited to the embodiments shown herein, but is intended to conform to the widest scope consistent with the principles and novel features disclosed herein.

What is claimed is:

1. A method for migrating memory data, comprising:
obtaining a migration instruction for a target process; the target process including at least one target thread; and
in response to the migration instruction, executing the following migration process for the target thread:
obtaining memory data corresponding to the at least one target thread;
determining whether the memory data is exclusively used by the target process;
when the memory data is exclusively used by the target process, migrating the memory data to a target memory block; and
when the memory data is not exclusively used by the target process, retaining the memory data in an original memory block.

2. The method of claim 1, wherein the memory data includes heap data corresponding to the at least one target thread; and
migrating the memory data to the target memory block includes:
selecting target data from the heap data to meet migration condition; and
using the at least one target thread to call a memory page migration interface, and having the memory page migration interface migrate the target data to the target memory block,
the target memory block is a memory block corresponding to a processing core to which the at least one target thread is to be migrated, and the memory block corresponding to the processing core provides a memory area for the processing core to perform data calculations.

3. The method of claim 2, wherein the migration condition includes: all data in the heap data that is exclusively used by the at least one target thread; or at least a portion of the data in the heap data that is exclusively used by the at least one target thread and has an access frequency greater than or equal to a threshold.

4. The method of claim 1, wherein, when there is only one target thread in the target process, the target memory block is the memory block corresponding to the processing core to which the target thread is migrated, and the memory block corresponding to the processing core provides a memory area for the processing core to perform data calculations,
when there are multiple target threads in the target process, the target memory block includes: memory blocks corresponding to the processing cores to which more than a target number of target threads in the target process are migrated, and the memory blocks corresponding to the processing core to which the target thread is migrated.

5. The method of claim 1, before migrating the memory data to the target memory block, further comprising:
using the target process's memory block mapping information, determining whether the memory block where the memory data resides is the same as the target memory block; the memory block mapping information includes mapping information between the memory data and the memory block where the memory data resides;
when the memory block where the memory data resides is the same as the target memory block, retaining the memory data in the original memory block;
when the memory block where the memory data resides is different from the target memory block, migrating the memory data to the target memory block.

6. The method of claim 1, wherein determining whether the memory data is exclusively used by the target process includes:
obtaining a data type of the memory data;
when the memory data is stack data, determining that the memory data is exclusively used by the target thread;
when the memory data is heap data, determining that the memory data is exclusively used by the target process;
when the memory data is a binary file, determining that the memory data is exclusively used by the target process;
when the memory data is a shared object file, determining whether the memory data is exclusively used by the target process based on the usage identification of the shared object file.

7. The method of claim 1, wherein migrating the memory data to the target memory block includes:
based on the data address range of the memory data, using a pre-arranged migration process to call a memory page migration interface, and having the memory page migration interface migrate the memory data to the target memory block.

8. The method of claim 7, wherein the data address range of the memory data is obtained based on address mapping information of the target process, and wherein the address mapping information includes mapping information between the memory data and start and end ranges of virtual memory addresses in which the memory data resides.

9. An electronic device, comprising: a memory storing computer program instructions; and
a processor coupled to the memory and configured to execute the computer program instructions and perform:
obtaining a migration instruction for a target process; the target process including at least one target thread; and
in response to the migration instruction, executing the following migration process for the target thread:
obtaining memory data corresponding to the at least one target thread;
determining whether the memory data is exclusively used by the target process;
when the memory data is exclusively used by the target process, migrating the memory data to a target memory block; and
when the memory data is not exclusively used by the target process, retaining the memory data in an original memory block.

10. The electronic device of claim 9, wherein the memory data includes heap data corresponding to the at least one target thread; and
migrating the memory data to the target memory block includes:
selecting target data from the heap data to meet migration condition; and
using the at least one target thread to call a memory page migration interface, and having the memory page migration interface migrate the target data to the target memory block,
the target memory block is a memory block corresponding to a processing core to which the at least one target thread is to be migrated, and the memory block corresponding to the processing core provides a memory area for the processing core to perform data calculations.

11. The electronic device of claim 10, wherein the migration condition includes: all data in the heap data that is exclusively used by the at least one target thread; or at least a portion of the data in the heap data that is exclusively used by the at least one target thread and has an access frequency greater than or equal to a threshold.

12. The electronic device of claim 9, wherein, when there is only one target thread in the target process, the target memory block is the memory block corresponding to the processing core to which the target thread is migrated, and the memory block corresponding to the processing core provides a memory area for the processing core to perform data calculations,
when there are multiple target threads in the target process, the target memory block includes: memory blocks corresponding to the processing cores to which more than a target number of target threads in the target process are migrated, and the memory blocks corresponding to the processing core to which the target thread is migrated.

13. The electronic device of claim 9, wherein, before migrating the memory data to the target memory block, the processor is further configured to perform:
using the target process's memory block mapping information, determining whether the memory block where the memory data resides is the same as the target memory block; the memory block mapping information includes mapping information between the memory data and the memory block where the memory data resides;
when the memory block where the memory data resides is the same as the target memory block, retaining the memory data in the original memory block;
when the memory block where the memory data resides is different from the target memory block, migrating the memory data to the target memory block.

14. The electronic device of claim 9, wherein determining whether the memory data is exclusively used by the target process includes:
obtaining a data type of the memory data;
when the memory data is stack data, determining that the memory data is exclusively used by the target thread;
when the memory data is heap data, determining that the memory data is exclusively used by the target process;
when the memory data is a binary file, determining that the memory data is exclusively used by the target process;
when the memory data is a shared object file, determining whether the memory data is exclusively used by the target process based on the usage identification of the shared object file.

15. The electronic device of claim 9, wherein migrating the memory data to the target memory block includes:
based on the data address range of the memory data, using a pre-arranged migration process to call a memory page migration interface, and having the memory page migration interface migrate the memory data to the target memory block.

16. The electronic device of claim 15, wherein the data address range of the memory data is obtained based on address mapping information of the target process, and wherein the address mapping information includes mapping information between the memory data and start and end ranges of virtual memory addresses in which the memory data resides.

17. A non-transitory computer-readable storage medium storing computer program instructions executable by at least one processor to perform:
obtaining a migration instruction for a target process; the target process including at least one target thread; and
in response to the migration instruction, executing the following migration process for the target thread:
obtaining memory data corresponding to the at least one target thread;
determining whether the memory data is exclusively used by the target process;
when the memory data is exclusively used by the target process, migrating the memory data to a target memory block; and
when the memory data is not exclusively used by the target process, retaining the memory data in an original memory block.

18. The non-transitory computer-readable storage medium of claim 17, wherein the memory data includes heap data corresponding to the at least one target thread; and
migrating the memory data to the target memory block includes:
selecting target data from the heap data to meet migration condition; and
using the at least one target thread to call a memory page migration interface, and having the memory page migration interface migrate the target data to the target memory block,
the target memory block is a memory block corresponding to a processing core to which the at least one target thread is to be migrated, and the memory block corresponding to the processing core provides a memory area for the processing core to perform data calculations.

19. The non-transitory computer-readable storage medium of claim 18, wherein the migration condition includes: all data in the heap data that is exclusively used by the at least one target thread; or at least a portion of the data in the heap data that is exclusively used by the at least one target thread and has an access frequency greater than or equal to a threshold.

20. The non-transitory computer-readable storage medium of claim 17, wherein, when there is only one target thread in the target process, the target memory block is the memory block corresponding to the processing core to which the target thread is migrated, and the memory block corresponding to the processing core provides a memory area for the processing core to perform data calculations,
when there are multiple target threads in the target process, the target memory block includes: memory blocks corresponding to the processing cores to which more than a target number of target threads in the target process are migrated, and the memory blocks corresponding to the processing core to which the target thread is migrated.
